(19) United States
(12) Patent Application Publication
(10) Pub. No.: US 2025/0150209 A1
(43) Pub. Date: May 8, 2025

(54) HYBRID AUTOMATIC REPEAT REQUEST (HARQ) PROCEDURES FOR SIDELINK OPERATING IN AN UNLICENSED BAND

(71) Applicant: Intel Corporation, Santa Clara, CA (US)

(72) Inventors: Salvatore Talarico, Santa Clara, CA (US); Kilian Roth, Munich (DE); Alexey Khoryaev, Santa Clara, CA (US); Sergey Panteleev, Kildare (IE); Mikhail Shilov, Santa Clara, CA (US)

(21) Appl. No.: 18/834,146

(22) PCT Filed: Apr. 21, 2023
(86) PCT No.: PCT/US2023/066084

§ 371 Date: Jul. 29, 2024

Related U.S. Application Data
(60) Provisional application No. 63/333,989, filed on Apr. 22, 2022.
(60) Provisional application No. 63/352,856, filed on Jun. 16, 2022.
(60) Provisional application No. 63/407,384, filed on Sep. 16, 2022.

(51) Int. Cl. H04L 1/1812; H04L 1/1867; H04W 72/0446; H04W 72/25; H04W 72/30; H04W 92/18

(52) U.S. Cl. CPC H04L 1/1812; H04L 1/1893; H04W 72/0446; H04W 72/25; H04W 72/30; H04W 92/18

(57) ABSTRACT

Various embodiments herein provide techniques related to hybrid automatic repeat request (HARQ) feedback of a new radio (NR) sidelink (SL) transmission. Specifically, in embodiments, a user equipment (UE) may perform, in a first slot of a plurality of slots, a listen before talk (LBT) procedure related to a NR SL transmission. The UE may further identify a subset of two or more candidate slots of the plurality of slots for transmission of a HARQ message related to the LBT procedure. The UE may further transmit the HARQ message in a candidate slot of the two or more candidate slots. Other embodiments may be described and/or claimed.

### CROSS REFERENCE TO RELATED APPLICATION

The present application claims priority to U.S. Provisional Patent Application No. 63/333,989, which was filed Apr. 22, 2022; U.S. Provisional Patent Application No. 63/352,856, which was filed Jun. 16, 2022; and to U.S. Provisional Patent Application No. 63/407,384, which was filed Sep. 16, 2022.

### FIELD

Various embodiments generally may relate to the field of wireless communications. For example, some embodiments may relate to sidelink (SL) operation in the unlicensed band.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of modes of SL operation in the unlicensed spectrum, in accordance with various embodiments.

FIG. 2 illustrates an example of 1-to-many mapping(s) between a physical SL control channel (PSCCH)/physical SL shared channel (PSSCH) resource and physical SL feedback channel (PSFCH) resource occasions, in accordance with various embodiments.

FIG. 3 illustrates an example of one-to-many mapping(s) from a PSCCH/PSSCH slot to a PSFCH occasion, in accordance with various embodiments.

FIG. 4 illustrates an example of PSFCH resource determination for multi-transport block (TB) scheduling, in accordance with various embodiments.

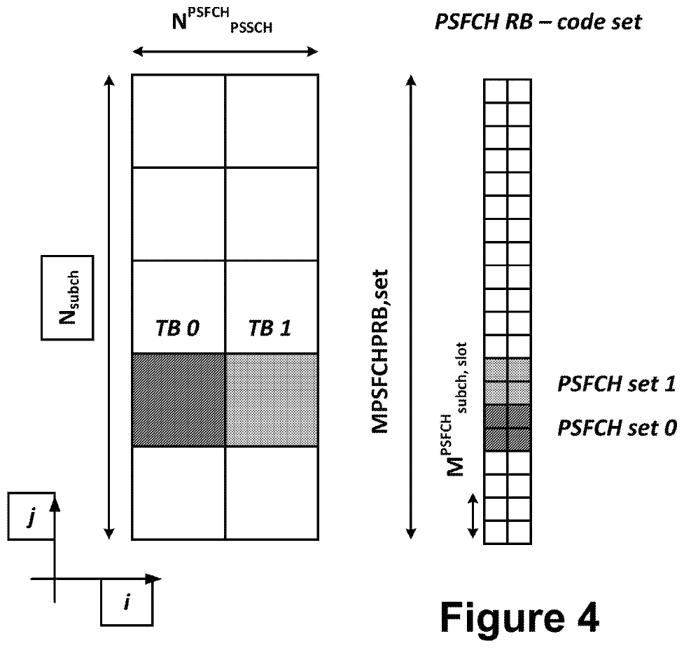

FIG. 5 schematically illustrates a wireless network in accordance with various embodiments.

FIG. 6 schematically illustrates components of a wireless network in accordance with various embodiments.

FIG. 7 is a block diagram illustrating components, according to some example embodiments, able to read instructions from a machine-readable or computer-readable medium (e.g., a non-transitory machine-readable storage medium) and perform any one or more of the methodologies discussed herein.

FIG. 8 illustrates a network 8 in accordance with various embodiments.

FIG. 9 depicts an example procedure for practicing the various embodiments discussed herein.

FIG. 10 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to today's highly sophisticated integrated communication platform. The next generation wireless communication system, which may be referred to as fifth generation (5G) and/or new radio (NR), may provide access to information and sharing of data anywhere, anytime by various users and applications. NR may be viewed as a unified network/system that may meet vastly different and sometime conflicting performance dimensions and services. Such diverse multi-dimensional requirements may be driven by factors such as different services and applications.

For instance, in the third generation partnership project (3GPP) release-16 (which may be referred to as Rel.16, Rel 16, Rel-16, etc.) specifications, SL communication was developed at least in part to support advanced vehicle-to-anything (V2X) applications. In the 3GPP Release-17 (which may be referred to herein as Rel.17, Rel 17, Rel-17, etc.) specifications, 3GPP studied and standardized proximity-based service including public safety and commercial related services. Further, as part of Rel.17, power saving solutions (e.g., partial sensing, discontinuous reception (DRX), etc.) and inter-UE coordination have been developed at least in part to improve power consumption for battery limited terminals and reliability of SL transmissions. Although NR SL may have initially been developed for V2X applications, there is growing interest in the industry to expand the applicability of NR SL to commercial use cases, such as sensor information (video) sharing between vehicles with high degree of driving automation. For commercial SL applications, two example requirements may be as follows:
Increased SL data rate
Support of new carrier frequencies for SL

To achieve these requirements, one objective of the 3GPP Release-18 (which may be referred to herein as Rel.18, Rel-18, Rel 18, etc.) specifications is to extend SL operation in the unlicensed spectrum, which may be referred to as NR-U SL in the remaining of this disclosure. However allow fair usage of the spectrum and fair coexistence among different technologies, different regional regulatory requirements are imposed worldwide. Thus, to enable a solution for all regions, complying with the strictest regulation from the European Telecommunications Standards Institute (ETSI) Broadband Radio Access Network (BRAN) committee as published, for example, in European Standard (EN) 301 893 may be sufficient. In fact, for the development of NR-U during Rel.16, a 3GPP NR based system complying with these regulations was developed.

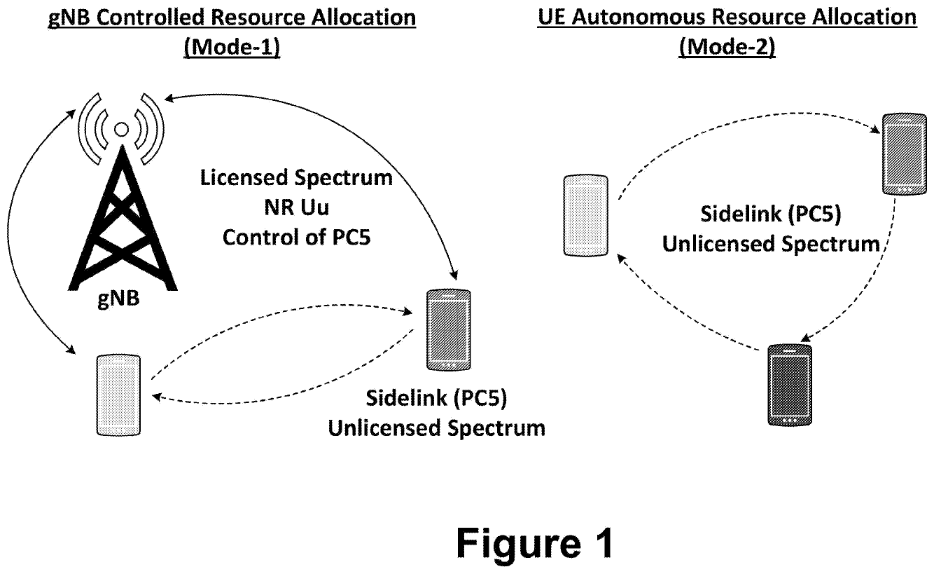

However, given that one target may be to enable a SL communication system in the unlicensed band, the considerations of SL communication systems may need to be combined with the regulator requirements necessary for the operation in the unlicensed bands. For example, NR SL may be operated through two modes of operation: 1) mode-1, where a base station such as a gNodeB (gNB) schedules the SL transmission resource(s) to be used by the UE, and Uu operation is limited to licensed spectrum only; and/or 2) mode-2, where a user equipment (UE) determines (i.e, gNB does not schedule) the SL transmission resource(s) within SL resources which are configured by the gNB/network or pre-configured. FIG. 1 illustrates examples of the two modes of operation.

In this context, there are several specific challenges to enable NR-U SL. In particular, one of the challenges is that, when operating in the frequency range-1 (FR-1, which may refer to frequencies at or below approximately 7 gigahertz (GHz) or, in some embodiments, at or below approximately 6 GHz) unlicensed band, a listen before talk (LBT) procedure may need to be performed to acquire the medium before a transmission can occur, which can potentially be performed at any time to significantly improve the overall system performance, requiring also a SL transmission to start soon after it, so that channel can be grabbed immediately.

Another feature when operating in the unlicensed spectrum is that the acquired channel by a device can be shared with other devices (e.g., between a user equipment (UE) and a base station such as a gNodeB (gNB)) to allow a more efficient use of a channel occupancy time (COT). Furthermore, ETSI BRAN mandates that at any time at least 80% of a nominal channel bandwidth should be occupied as specified through the following text:

4.2.2 Nominal Channel Bandwidth and Occupied Channel Bandwidth
4.2.1 Definition
The Nominal Channel Bandwidth is the widest band of frequencies, inclusive of guard
bands, assigned to a single channel.
The Occupied Channel Bandwidth is the bandwidth containing 99% of the power of
the signal.
When equipment has simultaneous transmission in adjacent channels, these
transmissions may be considered as one signal with an actual Nominal Channel
Bandwidth of “n” times the individual Nominal Channel Bandwidth where “n” is the
number of adjacent channels. When equipment has simultaneous transmissions in non-
adjacent channels, each power envelope shall be considered separately.
4.2.2.2 Limits
The Nominal Channel Bandwidth for a single Operating Channel shall be 20 MHz.
Alternatively, equipment may implement a lower Nominal Channel Bandwidth with a
minimum of 5 MHz, providing they still comply with the Nominal Centre Frequencies
defined in clause 4.2.1 (20 MHz raster).
The Occupied Channel Bandwidth shall be between 80% and 100% of the Nominal
Channel Bandwidth. In case of smart antenna systems (devices with multiple transmit
chains) each of the transmit chains shall meet this requirement. The Occupied Channel
Bandwidth might change with time/payload.
During a Channel Occupancy Time (COT), equipment may operate temporarily with
an Occupied Channel Bandwidth of less than 80% of its Nominal Channel Bandwidth
with a minimum of 2 MHz.

To fulfil these requirements, NR-U, licensed assisted access (LAA) and MulteFire have adopted an interleaved physical resource block (PRB) mapping, called interlaced mapping, which may be applied to physical uplink control channel (PUCCH) and/or the physical uplink shared channel (PUSCH). More importantly, for the synchronization signals the concept of Discovery Reference Signal (DRS) may be used, which may be composed of a synchronization signal (SS)/physical broadcast channel (PBCH) transmission and, optionally a non-zero power (NZP) channel state information (CSI)-reference signal (RS), physical downlink shared channel (PDSCH) transmission related to a system information block 1 (SIB1), and/or an associated physical downlink control channel (PDCCH) transmission.

Additionally, ETSI BRAN may define a specific class of signals, called short control signaling, which may be transmitted without any LBT or under specific LBT exceptions. A short control signal may be a signal that is not transmitted more than 50 times within any observation windows of 50 milliseconds (ms), and within any observation windows its aggregated transmission may not exceed 2.5 ms, as described by the following text:

4.2.7.3.3 Short Control Signalling Transmissions (FBE and LBE)
4.2.7.3.3.1 General
Frame Based Equipment and Load Based Equipment are allowed to have Short
Control Signalling Transmissions on the Operating Channel providing these
transmissions comply with the requirements in clause 4.2.7.3.3. It is not required for
adaptive equipment to implement Short Control Signalling Transmissions.
4.2.7.3.3.2 Definition
Short Control Signalling Transmissions are transmissions used by the equipment to
send management and control frames without sensing the channel for the presence
of other signals.
4.2.7.3.3.2 Limits
The use of Short Control Signalling Transmissions in constrained as follows:

| | |
|---|---|
| • | within an observation period of 50 ms, the number of Short Control |
| | Signalling Transmissions by the equipment shall be equal to or less than 50; |
| | and |
| • | the total duration of the equipment's Short Control Signalling Transmissions |
| | shall be less than 2500 μs within said observation period. |

In this sense, in NR-U the demodulation reference signal (DRS) may be the only signal qualified as a short control signaling, and in this sense a base station such as a gNB may be allowed to transmit this type of signal by using type 2A channel access to acquire the channel, instead of using type 1 LBT.

In Rel.16 NR SL, different hybrid automatic repeat request (HARQ) procedures for unicast/groupcast and broadcast operation may be defined, and they may rely on the physical SL feedback channel (PSFCH), which may be reliably transmitted and received. However, when operating in unlicensed spectrum, a transmission of PSFCH may be conditional to the success of the related LBT procedure. Furthermore, in order to increase the spectrum efficiency and utilization of a COT when operating in unlicensed spectrum, a UE may be allowed to transmit long SL transmissions, which may extend way past a single SL slot as in Rel.16 SL. With that said, the Rel.16 SL HARQ procedure may need to be enhanced, and multiple design considerations and options may be described herein.

### Time Relation of PSFCH to the Triggering PSCCH/PSSCH

Due to potential LBT failures, it may not be efficient to fix the timing relation between the triggering PSCCH/PSSCH and the corresponding PSFCH as was done for the Rel.16 SL design, which is meant to operate in the licensed spectrum. In particular, for a SL system operating in unlicensed spectrum, it may be highly beneficial to consider a procedure that allows multiple PSFCH transmission opportunities and/or self-contained/autonomous PSFCH transmissions which do not require 1:1 mapping to the triggering PSCCH/PSSCH resource. In this matter, multiple embodiments are provided in the following of this disclosure.

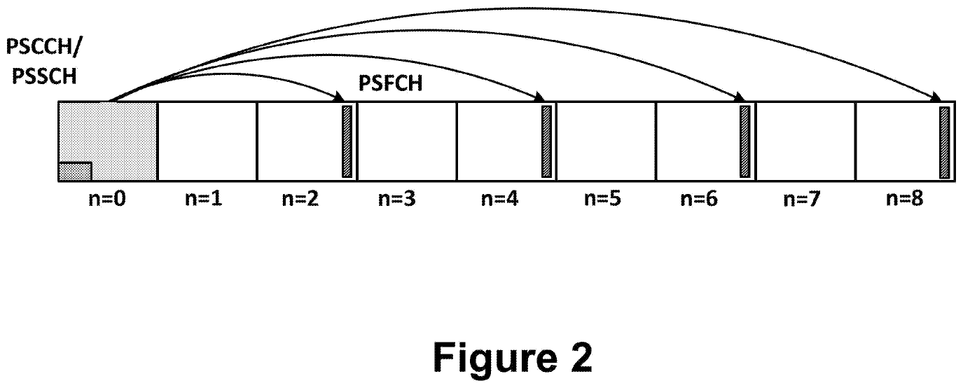

In one embodiment, multiple PSFCH transmission opportunities are configured, fixed, or may be (pre)-configured in the resource pool configuration as illustrated in FIG. 2. Specifically, as shown in FIG. 2, for a given PSCCH/PSSCH, there are four opportunities for a UE to perform LBT and transmit the corresponding PSFCH. It will be noted that in one embodiment, this may apply only for unicast communication, only for groupcast communication or in case of both, also as a different option additionally broadcast communication could be also included as well.

In this alternative, it is assumed that the PSCCH/PSSCH transmission resource has 1-to-many mapping with PSFCH resources in time domain. The multiple PSFCH transmission occasions could be either in different slots, or in different symbols of the same slot, or a combination of the two approaches. In one embodiment, sl-PSFCH-Period-r16 or periodPSFCHresource may indicate the cadence of the PSFCH occasion relative to the PSCCH/PSSCH resource, while a separate parameter indicates the number of PSFCH opportunities per PSCCH/PSSCH resource. In this case, it may also be ensured that the resources for each PSFCH transmission opportunity in the one-to-many mapping are orthogonal to the one-to-many mapping of any other transmission. This can be ensured by (pre)-configuration of different resources dependent on being the n-th transmission opportunity.

A redundancy order of R may be used to control the overhead, wherein R=1 means a single PSFCH occasion and R>1 means multiple PSFCH occasions. R may be fixed or (pre-) configurable per resource pool. Also, in one option, the multiple PSFCH transmission occasions may either only lie within the shared COT or may be allowed across different COTs. Additionally, transport block (TB) bundling with order L may be used to further control the overhead, wherein L=1 means each PSFCH refers to the HARQ feedback of a single TB, and L>1 means the hybrid automatic repeat request (HARQ)-acknowledgement (ACK) feedback of multiple TBs is bundled in a single PSFCH indication, where L may be fixed or (pre-) configurable per resource pool. In one option, bundling is applied such that ACK is reported in PSFCH if all TBs are received, and NACK (which may be a non-acknowledgement or negative acknowledgement) is reported if at least one TB is not received. In a different option, bundling is applied such that ACK is reported in PSFCH if at least one TBs is received, and NACK is reported if all TBs are not received.

Also in one option, the multiple PSFCH transmission occasions may either only lie within the shared COT or may be allowed across different COTs.

A given PSFCH occasion may correspond to >1 transport block. In this case, in one embodiment, either the same approach of parallel PSFCH transmissions could be used or, as an alternative a new multi-bit HARQ codebook design may be used, where a PSFCH may provide carry HARQ-ACK information for multiple TBs of the same UE or of different UEs.

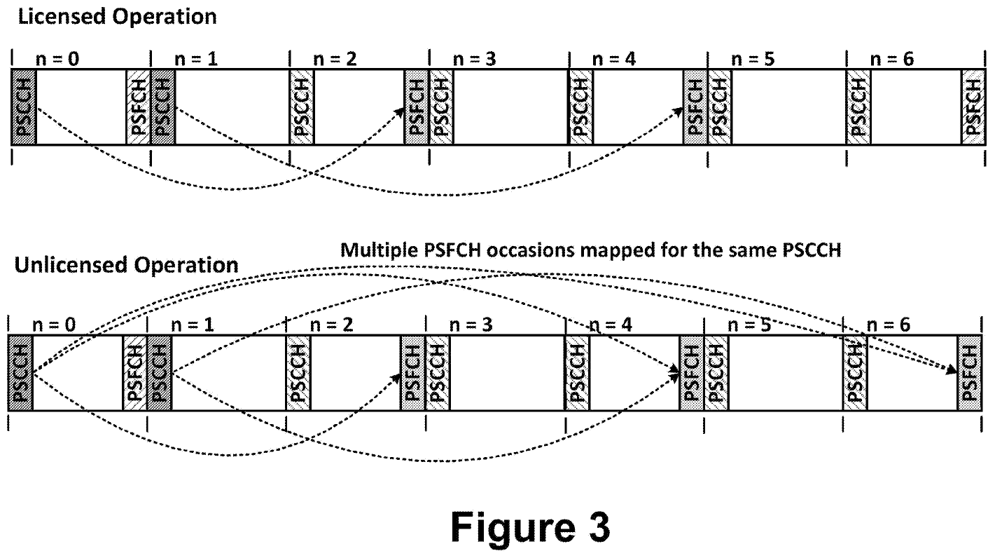

FIG. 3 provides a comparative example between the legacy Rel.16 SL HARQ procedure, which is based on 1:1 mapping between the triggering PSCCH/PSSCH transmission and the corresponding PSFCH, and a new HARQ approach defined for SL operating in unlicensed spectrum, which is based on a one-to-many mapping between the PSCCH/PSSCH slot and the PSFCH occasions.

In one embodiment, the PSFCH occasion or occasions are (pre-) configured or fixed. In another option, the PSFCH occasions or occasions related to a specific PSSCH is indicated dynamically within the SL control information (SCI) (e.g. either 1^{st} stage or 2 stage or both), in terms of time interval between the time when the corresponding PSSCH is transmitted and the slot where the related PSFCH occasion may occur, where the granularity could be at the symbol or slot level. In another option, the indication of the PSFCH occasion or occasions could be a combination of higher layer (pre-) configuration and SCI indication.

In one embodiment, if a PSFCH resource could not be transmitted within the same COT as the corresponding PSSCH, then the PSFCH is dropped. In this case, a UE may subsequently acquire a new COT, and trigger retransmission in the next available COT.

In one embodiment, if a PSFCH resource could not be transmitted due to LBT failure, the HARQ-ACK information is transmitted on following PSSCH via a medium access control (MAC)-control element (CE). In this case, the currently reserved octets may be used to carry one or more HARQ-ACK bits: in one option, N bits are transmitted each corresponding to the N HARQ-identifiers (IDs) available, and for those HARQ-ID(s) that are not configured for that UE, the UE may indicate either ACK or NACK.

In one embodiment, a new PSFCH format could be defined, for example PSFCH format 1, which may to carry HARQ-ACK information for multiple TBs of the same UE or of different UEs. In one option, this format is used based on pre-configuration or based on indication within the SCI of the UE performing the transmission, which may indicate that multi-TB transmission may be performed and format 1 may need to be used.

In one embodiment, when a new PSFCH format is introduced, the PSFCH transmission that carries multiple HARQ feedback may need to be always transmitted within a COT or as an alternative it may be always transmitted at the end of a COT. In one option, if HARQ feedback cannot be transmitted within a COT, a UE may subsequently acquire a new COT, and trigger retransmission in the next available COT for the TBs for which HARQ could not be transmitted.

In one embodiment, NACK-based feedback is not supported when operating in unlicensed spectrum for dynamic channel access mode or when the cg-RetransmissionTimer is enabled for semi-static channel access mode. In one embodiment, NACK-based feedback is supported when operating in unlicensed spectrum and for semi-static channel access mode when the cg-RetransmissionTimer is not enabled.

In one embodiment, for groupcast with a known communication range requirement, where the group context is not required to be established, ACK-based feedback is supported, instead of NACK-only-based feedback when operating in unlicensed spectrum regardless of whether operating in semi-static or dynamic channel access mode. In one embodiment, neither ACK-based or NACK-only-based feedback is supported when operating in unlicensed spectrum for dynamic channel access mode or when the cg-RetransmissionTimer is enabled for semi-static channel access mode. In one embodiment, ACK-based feedback is only supported for groupcast communication when operating in unlicensed spectrum and for semi-static channel access mode when the cg-RetransmissionTimer is not enabled.

In another embodiment, autonomous PSFCH transmission is configured. In this case, the PSFCH transmission may be autonomous or self-contained. That is, there is not one-to-one or one-to-many mapping from PSCCH/PSSCH resource to PSFCH resource(s), and PSFCH is monitored continuously in a window and carries a payload which can identify the source and the destination of the SL transmission and the corresponding HARQ-ACK bits. Notice that this procedure could be straightforwardly extended for multi-TB transmission from one or multiple UEs, and in this case the PSFCH may need to carry information for each TB or group of TB about the source and destination and for each TB indicate the corresponding HARQ-ACK information. In one embodiment, the window is fixed or pre-configured or could be related to the COT length within which the transmission(s) may have been performed.

In one embodiment, a retransmission timer concept may be introduced. The retransmission timer starts when the last symbol of PSCCH/PSSCH with the feedback request is received or starting from first symbol when this is transmitted. The retransmission timer expires after a configured/predefined number of slots or ms or symbols has been counted. When the retransmission timer expires, the UE drops the HARQ-ACK bit(s) or PSFCH without further attempting to retransmit it or in alternative when the retransmission timer expires, the UE may assume a NACK, and may retransmit.

In one embodiment, if a new PSFCH format is defined, the payload of such PSFCH format may at least include one or more of the following information:
Layer 1 (L1) source ID
L1 destination ID(s), which may either be a scalar or a vector.
HARQ-ACK bits corresponding to a set or all of HARQ process IDs
New data indicator (NDI) bits
Cyclic redundancy check (CRC)
COT sharing information when the UE transmitting the PSFCH may be either the initiating device or responding device:
whether the COT is shared, and how long the remaining COT may be.
Remaining COT information
Indication on whether the current device operates as initiating or responding device
Channel access priority class
Periodicity and/or offset for semi-static channel access mode

In another embodiment, the HARQ feedback is provided as a SCI on PSSCH piggyback. Assuming a unicast/groupcast connection is setup the related HARQ feedback could be transmitted as control information piggybacked on the PSSCH. In this case, the payload of SCI may at least include one or more of the following information:
L1 source ID
L1 destination ID, which may either be a scalar or a vector.
HARQ-ACK bits corresponding to a set of HARQ process IDs
NDI bits
CRC
COT sharing information when the UE transmitting the PSFCH may be either the initiating device or responding device:
whether the COT is shared, and how long the remaining COT may be.
Remaining COT information
Indication on whether the current device operates as initiating or responding device
Channel access priority class
Periodicity and/or offset for semi-static channel access mode

It will be understood that the embodiments listed here may not be mutually exclusive, and one or more of them may apply together.

### Sidelink HARQ-ACK for Multi-Slot and Multi-TB Transmission

Under the assumption that multi-slot transmission is introduced in SL to cope with LBT failures, and more importantly to have a better utilization of a COT, the legacy SL HARQ procedure may need to be revised accordingly.

For the case of single TB transmission over multiple slots, the procedures of one-to-one resource mapping between PSCCH/PSSCH and PSFCH slots may require modification in the way that the slot for calculation of the PSFCH occasion is derived from the last slot in the multi-slot bundle, not the initial slot. In this case, the UE has the time budget for processing all repetitions of the TB or all TB transmissions and prepare PSFCH with the feedback.

In one embodiment, when multi-slot transmission is composed by a burst of multiple repetitions of the same TP, the Rel.16 procedure for PSFCH resource determination is reused, where a PSFCH resource for a given TB is calculated from the slot index of the TB. This would lead to transmission of separate 1-bit PSFCH for different TBs.

In one embodiment, group TB bundling could be additionally applied. In this matter, a TB bundling with order L may be used to further control the overhead, wherein L=1 means each PSFCH set refers to the HARQ feedback of a single TB, and L>1 means the HARQ-ACK feedback of multiple TBs is bundled in a single PSFCH set indication, where L may be fixed or (pre-) configurable per resource pool. In one option, bundling is applied such that ACK is reported in PSFCH if all TBs are received, and NACK is reported if only a TB is not received. In a different option, bundling is applied such that ACK is reported in PSFCH if at least one TBs is received, and NACK is reported if all TBs are not received.

As indicated above, to carry HARQ-ACK information for multiple TBs and some of the information in prior embodiments, a new PSFCH format could be alternatively defined, which while may be still spanning over an orthogonal frequency division multiplexed (OFDM) symbol, it may carry two on more bits. In this sense, in one embodiment, this new PSFCH may be carry M_{bit}, b(0), . . . , b(M_{bit}−1) as physical uplink control channel (PUCCH) format 2. In particular, the M_{bit} bits could be scrambled using the pseudo code provided in Sec. 6.3.2.5.1 of the third generation partnership project (3GPP) technical specification (TS) 38.211 and modulated using quadrature phase shift keying (QPSK) as described in Sec. 6.3.2.5.2 of TS 38.211. While the procedure from PUCCH format 2 could be reused for this new PSFCH format, a new radio resource control (RRC) dataScramblingIdentityPSFCH could be also additionally defined, which may be used to set properly the value of nDD used in the scrambling procedure.

In one embodiment, spreading may be additionally applied to the complex-modulated symbols as described in Sec. 6.3.2.5.2.A in TS 38.211, using the same orthogonal cover code (OCC) defined in Rel.16 NR-U. In another embodiment, no spreading is applied to the complex-modulated symbols as they are mapped to a specific interlace.

### Uu Sidelink HARQ-ACK Due to Channel Access Failure

In one embodiment, a transmitting (TX) UE may report/generate a NACK to the associated gNB, when due to an LBT failure (e.g., either to acquire the COT, or access the channel within a shared COT) it may fail to transmit a scheduled PSSCH transmission whose resources were indicated by downlink control information (DCI).

In another embodiment, a TX UE may report/generate a NACK to the associated gNB, when due to an LBT failure (e.g., either to acquire the COT, or access the channel within a shared COT) it may fail to transmit a PSSCH transmission whose resources were provided via configured grant.

In another embodiment, a TX UE may report/generate a NACK to the associated gNB, if the UE does not receive PSFCH due to an LBT failure in any PSFCH reception occasions associated with a PSSSCH transmission in a resource provided by DCI.

In another embodiment, a TX UE may report/generate a NACK to the associated gNB, if the UE does not receive PSFCH due to an LBT failure in any PSFCH reception occasions associated with a PSSSCH transmission whose resources were provided via configured grant.

It will be understood that the embodiments listed here are not mutually exclusive, and one or more of them may apply together.

### Systems and Implementations

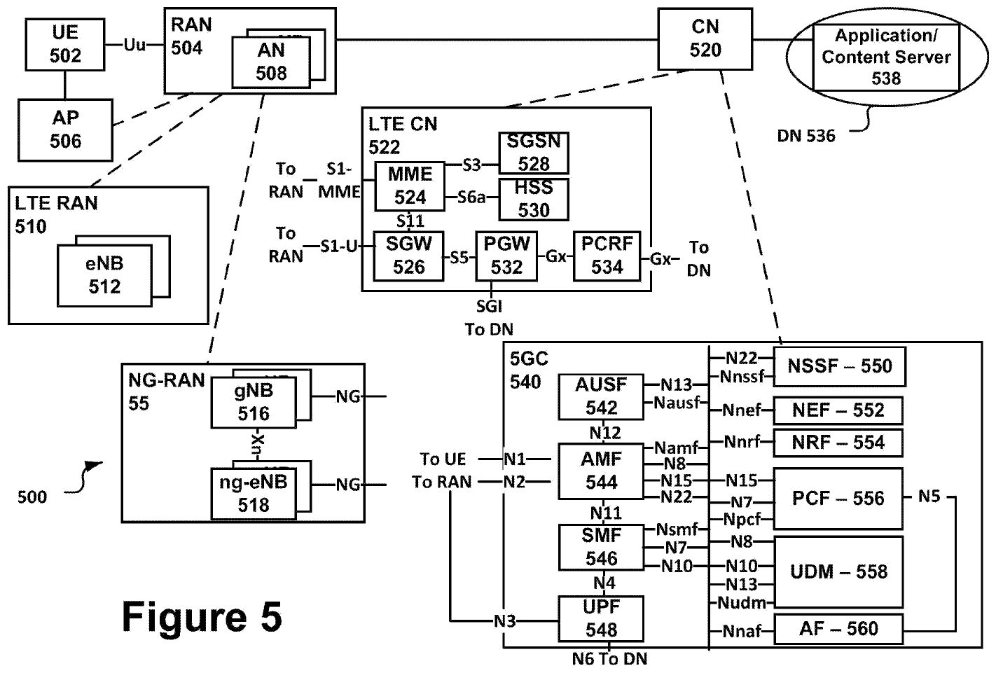

FIGS. 5-8 illustrate various systems, devices, and components that may implement aspects of disclosed embodiments.

FIG. 5 illustrates a network 500 in accordance with various embodiments. The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 802.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 504 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and L1 protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface.

In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN 514 and an AMF 544 (e.g., N2 interface).

The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an SI interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network 536 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, and AF 560 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management, mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (N1) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 552 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR 221 to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re) selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

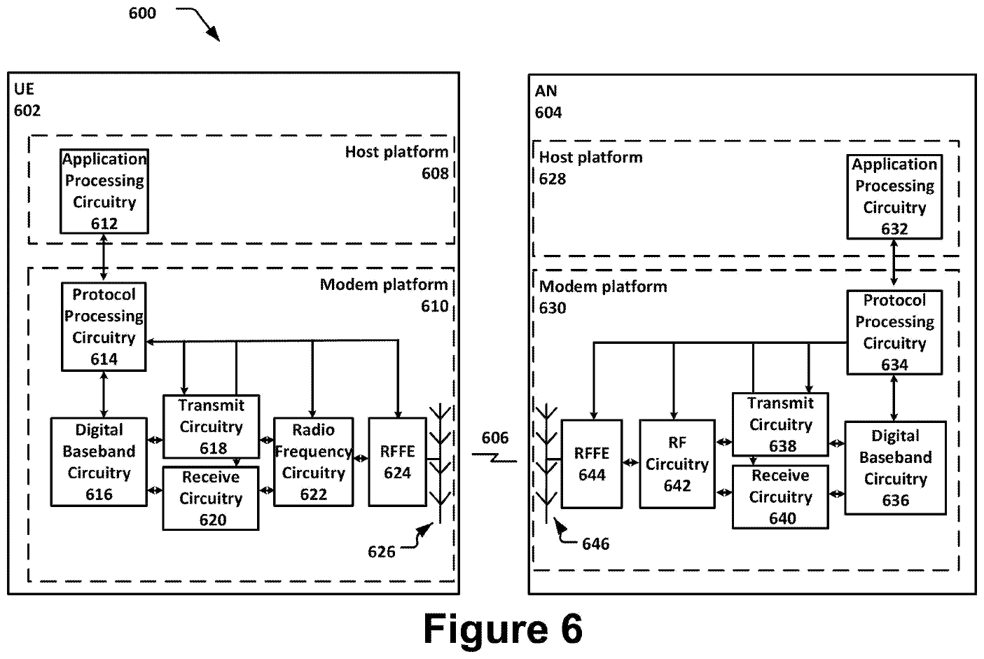

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mm Wave or sub-6 GHz frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 616 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

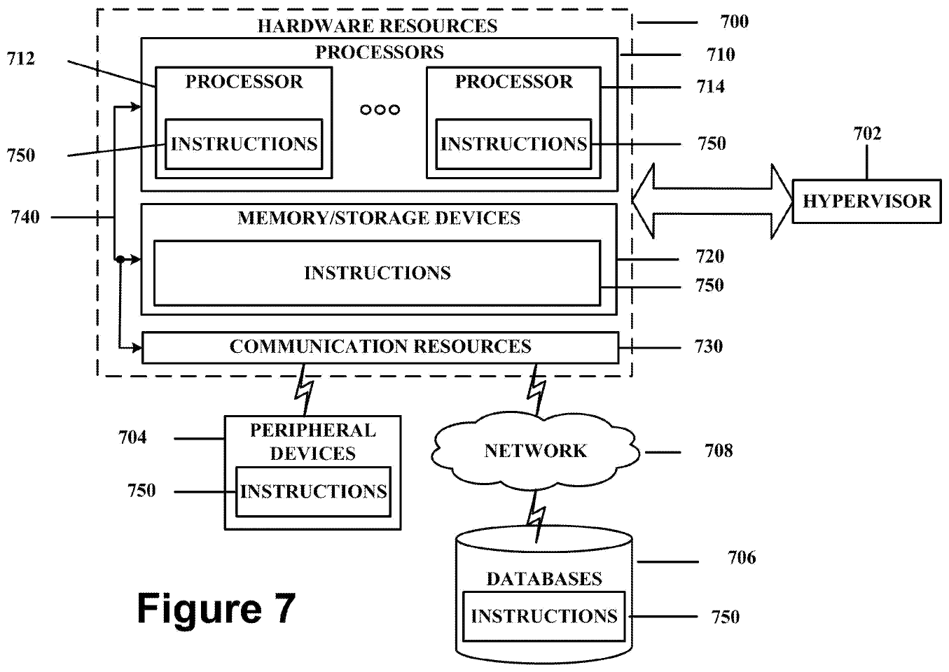

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

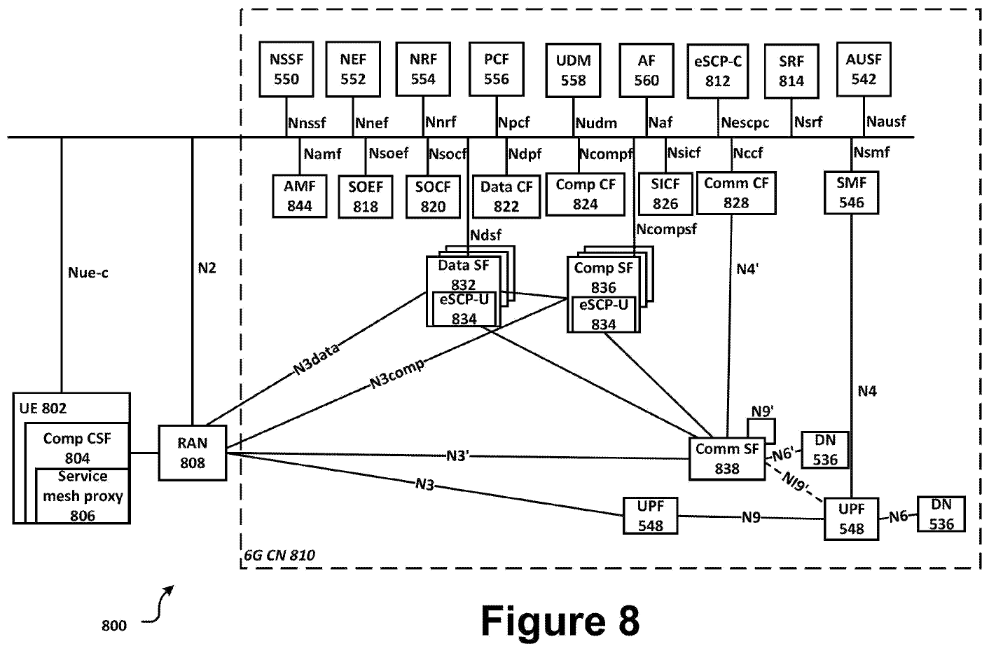

FIG. 8 illustrates a network 800 in accordance with various embodiments. The network 800 may operate in a matter consistent with 3GPP technical specifications or technical reports for 6G systems. In some embodiments, the network 800 may operate concurrently with network 500. For example, in some embodiments, the network 800 may share one or more frequency or bandwidth resources with network 500. As one specific example, a UE (e.g., UE 802) may be configured to operate in both network 800 and network 500. Such configuration may be based on a UE including circuitry configured for communication with frequency and bandwidth resources of both networks 500 and 800. In general, several elements of network 800 may share one or more characteristics with elements of network 500. For the sake of brevity and clarity, such elements may not be repeated in the description of network 800.

The network 800 may include a UE 802, which may include any mobile or non-mobile computing device designed to communicate with a RAN 808 via an over-the-air connection. The UE 802 may be similar to, for example, UE 502. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 8, in some embodiments the network 800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 8, the UE 802 may be communicatively coupled with an AP such as AP 506 as described with respect to FIG. 5. Additionally, although not specifically shown in FIG. 8, in some embodiments the RAN 808 may include one or more ANss such as AN 508 as described with respect to FIG. 5. The RAN 808 and/or the AN of the RAN 808 may be referred to as a base station (BS), a RAN node, or using some other term or name.

The UE 802 and the RAN 808 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 808 may allow for communication between the UE 802 and a 6G core network (CN) 810. Specifically, the RAN 808 may facilitate the transmission and reception of data between the UE 802 and the 6G CN 810. The 6G CN 810 may include various functions such as NSSF 550, NEF 552, NRF 554, PCF 556, UDM 558, AF 560, SMF 546, and AUSF 542. The 6G CN 810 may additional include UPF 548 and DN 536 as shown in FIG. 8.

Additionally, the RAN 808 may include various additional functions that are in addition to, or alternative to, functions of a legacy cellular network such as a 4G or 5G network. Two such functions may include a Compute Control Function (Comp CF) 824 and a Compute Service Function (Comp SF) 836. The Comp CF 824 and the Comp SF 836 may be parts or functions of the Computing Service Plane. Comp CF 824 may be a control plane function that provides functionalities such as management of the Comp SF 836, computing task context generation and management (e.g., create, read, modify, delete), interaction with the underlaying computing infrastructure for computing resource management, etc., Comp SF 836 may be a user plane function that serves as the gateway to interface computing service users (such as UE 802) and computing nodes behind a Comp SF instance. Some functionalities of the Comp SF 836 may include: parse computing service data received from users to compute tasks executable by computing nodes; hold service mesh ingress gateway or service API gateway; service and charging policies enforcement; performance monitoring and telemetry collection, etc. In some embodiments, a Comp SF 836 instance may serve as the user plane gateway for a cluster of computing nodes. A Comp CF 824 instance may control one or more Comp SF 836 instances.

Two other such functions may include a Communication Control Function (Comm CF) 828 and a Communication Service Function (Comm SF) 838, which may be parts of the Communication Service Plane. The Comm CF 828 may be the control plane function for managing the Comm SF 838, communication sessions creation/configuration/releasing, and managing communication session context. The Comm SF 838 may be a user plane function for data transport. Comm CF 828 and Comm SF 838 may be considered as upgrades of SMF 546 and UPF 548, which were described with respect to a 5G system in FIG. 5. The upgrades provided by the Comm CF 828 and the Comm SF 838 may enable service-aware transport. For legacy (e.g., 4G or 5G) data transport, SMF 546 and UPF 548 may still be used.

Two other such functions may include a Data Control Function (Data CF) 822 and Data Service Function (Data SF) 832 may be parts of the Data Service Plane. Data CF 822 may be a control plane function and provides functionalities such as Data SF 832 management, Data service creation/configuration/releasing, Data service context management, etc. Data SF 832 may be a user plane function and serve as the gateway between data service users (such as UE 802 and the various functions of the 6G CN 810) and data service endpoints behind the gateway. Specific functionalities may include include: parse data service user data and forward to corresponding data service endpoints, generate charging data, report data service status.

Another such function may be the Service Orchestration and Chaining Function (SOCF) 820, which may discover, orchestrate and chain up communication/computing/data services provided by functions in the network. Upon receiving service requests from users, SOCF 820 may interact with one or more of Comp CF 824, Comm CF 828, and Data CF 822 to identify Comp SF 836, Comm SF 838, and Data SF 832 instances, configure service resources, and generate the service chain, which could contain multiple Comp SF 836, Comm SF 838, and Data SF 832 instances and their associated computing endpoints. Workload processing and data movement may then be conducted within the generated service chain. The SOCF 820 may also responsible for maintaining, updating, and releasing a created service chain.

Another such function may be the service registration function (SRF) 814, which may act as a registry for system services provided in the user plane such as services provided by service endpoints behind Comp SF 836 and Data SF 832 gateways and services provided by the UE 802. The SRF 814 may be considered a counterpart of NRF 554, which may act as the registry for network functions.

Other such functions may include an evolved service communication proxy (eSCP) and service infrastructure control function (SICF) 826, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 812 and eSCP-U 834, for control plane service communication proxy and user plane service communication proxy, respectively. The SICF 826 may control and configure eCSP instances in terms of service traffic routing policies, access rules, load balancing configurations, performance monitoring, etc.

Another such function is the AMF 844. The AMF 844 may be similar to 544, but with additional functionality. Specifically, the AMF 844 may include potential functional repartition, such as move the message forwarding functionality from the AMF 844 to the RAN 808.

Another such function is the service orchestration exposure function (SOEF) 818. The SOEF may be configured to expose service orchestration and chaining services to external users such as applications.

The UE 802 may include an additional function that is referred to as a computing client service function (comp CSF) 804. The comp CSF 804 may have both the control plane functionalities and user plane functionalities, and may interact with corresponding network side functions such as SOCF 820, Comp CF 824, Comp SF 836, Data CF 822, and/or Data SF 832 for service discovery, request/response, compute task workload exchange, etc. The Comp CSF 804 may also work with network side functions to decide on whether a computing task should be run on the UE 802, the RAN 808, and/or an element of the 6G CN 810.

The UE 802 and/or the Comp CSF 804 may include a service mesh proxy 806. The service mesh proxy 806 may act as a proxy for service-to-service communication in the user plane. Capabilities of the service mesh proxy 806 may include one or more of addressing, security, load balancing, etc.

### Example Procedures

In some embodiments, the electronic device(s), network(s), system(s), chip(s) or component(s), or portions or implementations thereof, of FIGS. 5-7, or some other figure herein, may be configured to perform one or more processes, techniques, or methods as described herein, or portions thereof.

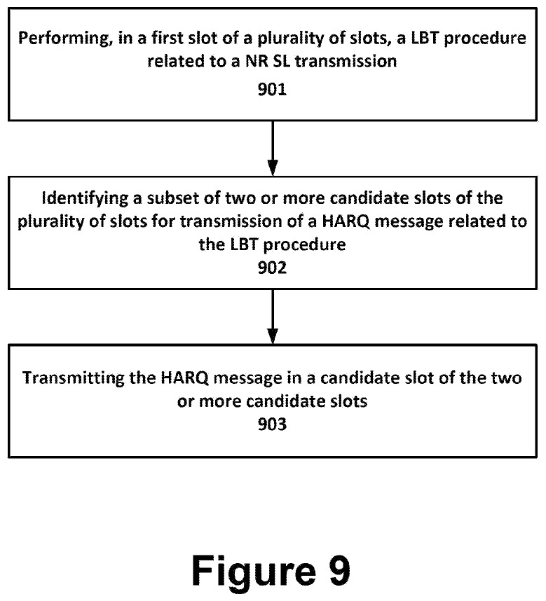

One such process is depicted in FIG. 9. The process of FIG. 9 may include or relate to a method to be performed by a user equipment (UE), one or more elements of a UE, and/or one or more electronic devices that include and/or implement a UE. The process may include performing, at 901 in a first slot of a plurality of slots, a listen before talk (LBT) procedure related to a new radio (NR) sidelink (SL) transmission; identifying, at 902, a subset of two or more candidate slots of the plurality of slots for transmission of a hybrid automatic repeat request (HARQ) message related to the LBT procedure; and transmitting, at 903, the HARQ message in a candidate slot of the two or more candidate slots.

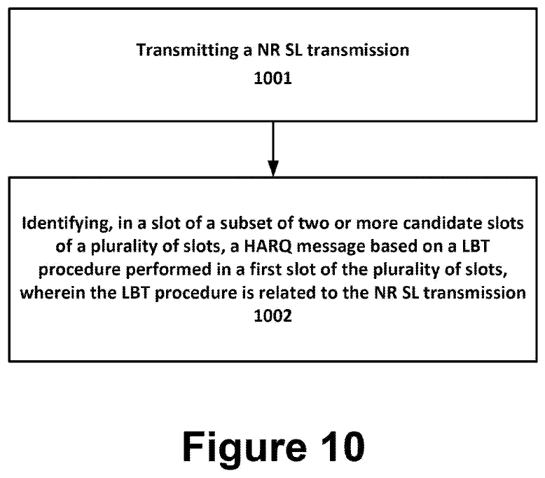

Another such process is depicted in FIG. 10. The process of FIG. 10 may include or relate to a method to be performed by a user equipment (UE), one or more elements of a UE, and/or one or more electronic devices that include and/or implement a UE. The process may include transmitting, at 1001, a new radio (NR) sidelink (SL) transmission; and identifying, at 1002 in a slot of a subset of two or more candidate slots of a plurality of slots, a hybrid automatic repeat request (HARQ) message based on a listen before talk (LBT) procedure performed in a first slot of the plurality of slots, wherein the LBT procedure is related to the NR SL transmission.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include the procedure to enable unicast HARQ feedback for the SL operation in unlicensed spectrum;

Example 2 may include the procedure to enable groupcast HARQ feedback for the SL operation in unlicensed spectrum;

Example 3 may include the procedure to enable broadcast HARQ feedback for the SL operation in unlicensed spectrum;

Example 4 may include the procedure to support HARQ feedback for multiple-slot transmissions;

Example 5 may include new PSFCH format is defined to carry HARQ-ACK information for multiple TBs and some information to allow COT sharing and feedback HARQ information to different UEs.

Example 6 includes a method to be performed by a user equipment (UE), one or more elements of a UE, and/or an electronic device that includes a UE, wherein the method comprises: identifying a physical sidelink shared channel (PSSCH) transmission; and transmitting, based on the PSSCH transmission, a hybrid automatic repeat request acknowledgement (HARQ-ACK) in a physical sidelink feedback channel (PSFCH) transmission; wherein one or both of the PSSCH transmission and the PSFCH transmission are in an unlicensed band.

Example 7 include a method to be performed by an electronic device, wherein the method comprises: transmitting a physical sidelink shared channel (PSSCH) transmission; and identifying, based on the PSSCH transmission, a hybrid automatic repeat request acknowledge (HARQ-ACK) in a physical sidelink feedback channel (PSFCH) transmission; wherein one or both of the PSSCH transmission and the PSFCH transmission are in an unlicensed band.

Example 8 includes the method of example 7, and/or some other example herein, wherein the electronic device is a user equipment (UE), one or more elements of a UE, or an electronic device that includes a UE.

Example 9 includes the method of example 7, and/or some other example herein, wherein the electronic device is a base station, one or more elements of a base station, or an electronic device that includes a base station.

Example 10 may include the method of any of examples 7-9, and/or some other example herein, wherein the electronic device is a UE and the method further comprises generating/transmitting, to a gNB a NACK if the transmission of the PSSCH fails or the UE does not receive the PSFCH transmission.

Example 11 may include the method of any of examples 7-10, and/or some other example herein, wherein an occasion for transmission of the PSFCH is pre-configured or fixed.

Example 12 may include a method to be performed by a user equipment (UE), one or more elements of a UE, and/or one or more electronic devices that include and/or implement a UE, wherein the method comprises: performing, in a first slot of a plurality of slots, a listen before talk (LBT) procedure related to a new radio (NR) sidelink (SL) transmission; identifying a subset of two or more candidate slots of the plurality of slots for transmission of a hybrid automatic repeat request (HARQ) message related to the LBT procedure; and transmitting the HARQ message in a candidate slot of the two or more candidate slots.

Example 13 may include the method of example 12, and/or some other example herein, wherein the subset of two or more candidate slots includes four candidate slots.

Example 14 may include the method of any of examples 12-13, and/or some other example herein, wherein transmission of the HARQ message includes transmission of the HARQ message in a physical SL feedback channel (PSFCH) transmission.

Example 15 may include the method of any of examples 12-14, and/or some other example herein, wherein transmitting the HARQ message is performed via unicast transmission.

Example 16 may include the method of any of examples 12-14, and/or some other example herein, wherein transmitting the HARQ message is performed via groupcast transmission.

Example 17 may include the method of any of examples 12-14, and/or some other example herein, wherein transmitting the HARQ message is performed via broadcast transmission.

Example 18 may include the method of any of examples 12-17, and/or some other example herein, wherein a non-candidate slot is between respective slots of the two or more candidate slots in the plurality of slots.

Example 19 may include the method of any of examples 12-18, and/or some other example herein, wherein the NR SL transmission is a physical SL control channel (PSCCH) transmission or a physical SL shared channel (PSSCH) transmission.

Example 20 may include a method to be performed by a user equipment (UE), one or more elements of a UE, and/or one or more electronic devices that include and/or implement a UE, wherein the method comprises: transmitting a new radio (NR) sidelink (SL) transmission; and identifying, in a slot of a subset of two or more candidate slots of a plurality of slots, a hybrid automatic repeat request (HARQ) message based on a listen before talk (LBT) procedure performed in a first slot of the plurality of slots, wherein the LBT procedure is related to the NR SL transmission.

Example 21 may include the method of example 20, and/or some other example herein, wherein the subset of two or more candidate slots includes four candidate slots.

Example 22 may include the method of any of examples 20-21, and/or some other example herein, wherein identification of the HARQ message includes identification of the HARQ message in a physical SL feedback channel (PSFCH) transmission.

Example 23 may include the method of any of examples 20-22, wherein the HARQ message is transmitted via unicast transmission.

Example 24 may include the method of any of examples 20-22, wherein the HARQ message is transmitted via groupcast transmission.

Example 25 may include the method of any of examples 20-22, wherein the HARQ message is transmitted via broadcast transmission.

Example 26 may include the method of any of examples 20-25, and/or some other example herein, wherein a non-candidate slot is between respective slots of the two or more candidate slots in the plurality of slots.

Example 27 may include the method of any of examples 20-26, and/or some other example herein, wherein the NR SL transmission is a physical SL control channel (PSCCH) transmission or a physical SL shared channel (PSSCH) transmission.

Example Z01 may include an apparatus comprising means to perform one or more elements of a method described in or related to any of examples 1-27, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Example Z03 may include an apparatus comprising logic, modules, or circuitry to perform one or more elements of a method described in or related to any of examples 1-27, or any other method or process described herein.

Example Z04 may include a method, technique, or process as described in or related to any of examples 1-27, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-27, or portions thereof.

Example Z06 may include a signal as described in or related to any of examples 1-27, or portions or parts thereof.

Example Z07 may include a datagram, packet, frame, segment, protocol data unit (PDU), or message as described in or related to any of examples 1-27, or portions or parts thereof, or otherwise described in the present disclosure.

Example Z08 may include a signal encoded with data as described in or related to any of examples 1-27, or portions or parts thereof, or otherwise described in the present disclosure.

Example Z09 may include a signal encoded with a datagram, packet, frame, segment, protocol data unit (PDU), or message as described in or related to any of examples 1-27, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Example Z11 may include a computer program comprising instructions, wherein execution of the program by a processing element is to cause the processing element to carry out the method, techniques, or process as described in or related to any of examples 1-27, or portions thereof.

Example Z12 may include a signal in a wireless network as shown and described herein. Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership |
| | Project |
| 4G | Fourth |
| | Generation |
| 5G | Fifth Generation |
| 5GC | 5G Core |
| | network |
| AC | Application |
| | Client |
| ACR | Application |
| | Context Relocation |
| ACK | Acknowledgement |
| ACID | Application |
| | Client Identification |
| AF | Application |
| | Function |
| AM | Acknowledged |
| | Mode |
| AMBR | Aggregate |
| | Maximum Bit Rate |
| AMF | Access and |
| | Mobility |
| | Management |
| | Function |
| AN | Access Network |
| ANR | Automatic |
| | Neighbour Relation |
| AOA | Angle of |
| | Arrival |
| AP | Application |
| | Protocol, Antenna |
| | Port, Access Point |
| API | Application |
| | Programming Interface |
| APN | Access Point |
| | Name |
| ARP | Allocation and |
| | Retention Priority |
| ARQ | Automatic |
| | Repeat Request |
| AS | Access Stratum |
| ASP | Application Service |
| | Provider |
| ASN.1 | Abstract Syntax |
| | Notation One |
| AUSF | Authentication |
| | Server Function |
| AWGN | Additive White |
| | Gaussian Noise |
| BAP | Backhaul |
| | Adaptation Protocol |
| BCH | Broadcast Channel |
| BER | Bit Error Ratio |
| BFD | Beam Failure |
| | Detection |
| BLER | Block Error Rate |
| BPSK | Binary Phase |
| | Shift Keying |
| BRAS | Broadband Remote |
| | Access Server |
| BSS | Business Support |
| | System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based |
| | Random Access |
| CC | Component Carrier, |
| | Country Code, |
| | Cryptographic |
| | Checksum |
| CCA | Clear Channel |
| | Assessment |
| CCE | Control Channel |
| | Element |
| CCCH | Common Control |
| | Channel |
| CE | Coverage Enhancement |
| CDM | Content Delivery |
| | Network |
| CDMA | Code-Division |
| | Multiple Access |
| CDR | Charging Data |
| | Request |
| CDR | Charging Data |
| | Response |
| CFRA | Contention Free |
| | Random Access |
| CG | Cell Group |
| CGF | Charging |
| | Gateway Function |
| CHF | Charging |
| | Function |
| CI | Cell Identity |
| CID | Cell-ID (e.g., |
| | positioning method) |
| CIM | Common |
| | Information Model |
| CIR | Carrier to |
| | Interference Ratio |
| CK | Cipher Key |
| CM | Connection |
| | Management, |
| | Conditional |
| | Mandatory |
| CMAS | Commercial |
| | Mobile Alert Service |
| CMD | Command |
| CMS | Cloud |
| | Management System |
| CO | Conditional Optional |
| CoMP | Coordinated |
| | Multi-Point |
| CORESET | Control Resource Set |
| COTS | Commercial Off- |
| | The-Shelf |
| CP | Control Plane, |
| | Cyclic Prefix, |
| | Connection Point |
| CPD | Connection |
| | Point Descriptor |
| CPE | Customer Premise |
| | Equipment |
| CPICH | Common Pilot |
| | Channel |
| CQI | Channel Quality |
| | Indicator |
| CPU | CSI processing |
| | unit, Central |
| | Processing Unit |
| C/R | Command/Response |
| | field bit |
| CRAN | Cloud Radio |
| | Access Network, |
| | Cloud RAN |
| CRB | Common |
| | Resource Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSCF | call session control |
| | function |
| CSAR | Cloud Service Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise |
| | and interference ratio |
| CSMA | Carrier Sense Multiple |
| | Access |
| CSMA/CA | CSMA with collision |
| | avoidance |
| CSS | Common Search |
| | Space, Cell-specific |
| | Search Space |
| CTF | Charging Trigger |
| | Function |
| CTS | Clear-to-Send |
| CW | Codeword |
| CWS | Contention Window |
| | Size |
| D2D | Device-to-Device |
| DC | Dual Connectivity, |
| | Direct Current |
| DCI | Downlink Control |
| | Information |
| DF | Deployment |
| | Flavour |
| DL | Downlink |
| DMTF | Distributed Management |
| | Task Force |
| DPDK | Data Plane |
| | Development Kit |
| DM-RS, DMRS | Demodulation |
| | Reference Signal |
| DN | Data network |
| DNN | Data Network Name |
| DNAI | Data Network |
| | Access Identifier |
| DRB | Data Radio Bearer |
| DRS | Discovery Reference |
| | Signal |
| DRX | Discontinuous |
| | Reception |
| DSL | Domain Specific |
| | Language. Digital |
| | Subscriber Line |
| DSLAM | DSL |
| | Access Multiplexer |
| DwPTS | Downlink Pilot |
| | Time Slot |
| E-LAN | Ethernet |
| | Local Area Network |
| E2E | End-to-End |
| EAS | Edge Application |
| | Server |
| ECCA | extended clear |
| | channel assessment, |
| | extended CCA |
| ECCE | Enhanced Control |
| | Channel Element, |
| | Enhanced CCE |
| ED | Energy Detection |
| EDGE | Enhanced Datarates |
| | for GSM Evolution |
| | (GSM Evolution) |
| EAS | Edge Application |
| | Server |
| EASID | Edge Application |
| | Server Identification |
| ECS | Edge Configuration Server |
| ECSP | Edge Computing |
| | Service Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | Management Function |
| EGPRS | Enhanced GPRS |
| EIR | Equipment |
| | Identity Register |
| eLAA | enhanced Licensed |
| | Assisted Access, |
| | enhanced LAA |
| EM | Element Manager |
| eMBB | Enhanced Mobile |
| | Broadband |
| EMS | Element |
| | Management System |
| eNB | evolved NodeB, |
| | E-UTRAN Node B |
| EN-DC | E-UTRA-NR Dual |
| | Connectivity |
| EPC | Evolved Packet Core |
| EPDCCH | enhanced Physical |
| | Downlink Control |
| | Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit |
| | Card |
| E-UTRA | Evolved UTRA |
| E-UTRAN | Evolved UTRAN |
| EV2X | Enhanced V2X |
| F1AP | F1 Application Protocol |
| F1-C | F1 Control plane |
| | interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access |
| | Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, |
| | GSM EDGE Radio |
| | Access Network |
| GGSN | Gateway GPRS |
| | Support Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CU | gNB-centralized unit, Next |
| | Generation NodeB |
| | centralized unit |
| gNB-DU | gNB-distributed unit, Next |
| | Generation NodeB |
| | distributed unit |
| GNSS | Global Navigation Satellite |
| | System |
| GPRS | General Packet Radio |
| | Service |
| GPSI | Generic Public Subscription |
| | Identifier |
| GSM | Global System |
| | for Mobile |
| | Communications, Groupe |
| | Spécial Mobile |
| GTP | GPRS Tunneling |
| | Protocol |
| GTP-UGPRS | Tunnelling Protocol |
| | for User Plane |
| GTS | Go To Sleep Signal (related |
| | WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence Number |
| HSPA | High Speed Packet Access |
| HSS | Home Subscriber Server |
| HSUPA | High Speed Uplink |
| | Packet |
| HTTP | Hyper Text Transfer |
| | Protocol |
| HTTPS | Hyper Text Transfer |
| | Protocol Secure (https is |
| | http/1.1 over SSL, i.e. |
| | port 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical and |
| | Electronics Engineers |
| IEI | Information Element |
| | Identifier |
| IEIDL | Information Element |
| | Identifier Data Length |
| IETF | Internet Engineering Task |
| | Force |
| IF | Infrastructure |
| IIOT | Industrial Internet of Things |
| IM | Interference Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity Access |
| | Network |
| IP-M | IP Multicast |
| IPv4 | Internet Protocol Version 4 |
| IPv6 | Internet Protocol Version 6 |
| IR | Infrared |
| IS | In Sync |
| IRP | Integration |
| | Reference Point |
| ISDN | Integrated Services |
| | Digital Network |
| ISIM | IM Services Identity |
| | Module |
| ISO | International Organisation |
| | for Standardisation |
| ISP | Internet Service Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal |
| | received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer Compatibility |
| LMF | Location Management |
| | Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level |
| | Integration with IPsec |
| | Tunnel |
| LTE | Long Term Evolution |
| M2M | Machine-to-Machine |
| MAC | Medium Access Control |
| | (protocol layering context) |
| MAC | Message authentication |
| | code (security/encryption |
| | context) |
| MAC-A | MAC used for authentication |
| | and key agreement (TSG |
| | TWG3 context) |
| MAC-IMAC | used for data integrity of |
| | signalling messages |
| | (TSG T WG3 context) |
| MANO | Management and |
| | Orchestration |
| MBMS | Multimedia Broadcast |
| | and Multicast Service |
| MBSFN | Multimedia Broadcast |
| | multicast service Single |
| | Frequency Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data Analytics |
| | Function |
| MDAS | Management Data Analytics |
| | Service |
| MDT | Minimization of Drive |
| | Tests |
| ME | Mobile Equipment |
| MeNB | master eNB |
| MER | Message Error Ratio |
| MGL | Measurement Gap Length |
| MGRP | Measurement Gap |
| | Repetition Period |
| MIB | Master Information Block, |
| | Management Information |
| | Base |
| MIMO | Multiple Input Multiple |
| | Output |
| MLC | Mobile Location Centre |
| MM | Mobility Management |
| MME | Mobility Management Entity |
| MN | Master Node |
| MNO | Mobile Network Operator |
| MO | Measurement Object, |
| | Mobile Originated |
| MPBCH | MTC Physical Broadcast |
| | CHannel |
| MPDCCH | MTC Physical Downlink |
| | Control CHannel |
| MPDSCH | MTC Physical Downlink |
| | Shared CHannel |
| MPRACH | MTC Physical Random |
| | Access CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching Centre |
| MSI | Minimum System |
| | Information, MCH |
| | Scheduling Information |
| MSID | Mobile Station Identifier |
| MSIN | Mobile Station Identification |
| | Number |
| MSISDN | Mobile Subscriber ISDN |
| | Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative Acknowledgement |
| NAI | Network Access Identifier |
| NAS | Non-Access Stratum, |
| | Non-Access Stratum layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure Function |
| NF | Network Function |
| NFP | Network Forwarding |
| | Path |
| NFPD | Network Forwarding Path |
| | Descriptor |
| NFV | Network Functions |
| | Virtualization |
| NFVI | NFV Infrastructure |
| NFVO | NFV Orchestrator |
| NG | Next Generation, Next Gen |
| NGEN-DC | NG-RAN E-UTRA-NR |
| | Dual Connectivity |
| NM | Network Manager |
| NMS | Network |
| | Management System |
| N-PoP | Network Point of Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared CHannel |
| NPRACH | Narrowband Physical |
| | Random Access CHannel |
| NPUSCH | Narrowband Physical |
| | Uplink Shared CHannel |
| NPSS | Narrowband Primary |
| | Synchronization Signal |
| NSSS | Narrowband Secondary |
| | Synchronization Signal |
| NR | New Radio, Neighbour |
| | Relation |
| NRF | NF Repository Function |
| NRS | Narrowband Reference |
| | Signal |
| NS | Network Service |
| NSA | Non-Standalone operation |
| | mode |
| NSD | Network Service Descriptor |
| NSR | Network Service Record |
| NSSAI | Network Slice Selection |
| | Assistance Information |
| S-NNSAI | Single-NSSAI |
| NSSF | Network Slice Selection |
| | Function |
| NW | Network |
| NWUS | Narrowband wake-up |
| | signal, Narrowband WUS |
| NZP | Non-Zero Power |
| O&M | Operation and Maintenance |
| ODU2 | Optical channel Data Unit - |
| | type 2 |
| OFDM | Orthogonal Frequency |
| | Division Multiplexing |
| OFDMA | Orthogonal Frequency |
| | Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power |
| | Ratio |
| PAR | Peak to Average Ratio |
| PBCH | Physical Broadcast Channel |
| PC | Power Control, Personal |
| | Computer |
| PCC | Primary Component Carrier, |
| | Primary CC |
| P-CSCF | Proxy CSCF |
| PCell | Primary Cell |
| PCI | Physical Cell ID, |
| | Physical Cell Identity |
| PCEF | Policy and Charging |
| | Enforcement Function |
| PCF | Policy Control Function |
| PCRF | Policy Control and Charging |
| | Rules Function |
| PDCP | Packet Data Convergence |
| | Protocol, Packet Data |
| | Convergence Protocol layer |
| PDCCH | Physical Downlink Control |
| | Channel |
| PDCP | Packet Data Convergence |
| | Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance Measurement |
| PMI | Precoding Matrix Indicator |
| PNF | Physical Network Function |
| PNFD | Physical Network Function |
| | Descriptor |
| PNFR | Physical Network Function |
| | Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block |
| | group |
| ProSe | Proximity Services, |
| | Proximity-Based Service |
| PRS | Positioning Reference |
| | Signal |
| PRR | Packet Reception Radio |
| PS | Packet Services |
| PSBCH | Physical Sidelink Broadcast |
| | Channel |
| PSDCH | Physical Sidelink Downlink |
| | Channel |
| PSCCH | Physical Sidelink Control |
| | Channel |
| PSSCH | Physical Sidelink Shared |
| | Channel |
| PSFCH | physical sidelink feedback |
| | channel |
| PSCell | Primary SCell |
| PSS | Primary Synchronization |
| | Signal |
| PSTN | Public Switched Telephone |
| | Network |
| PT-RS | Phase-tracking reference |
| | signal |
| PTT | Push-to-Talk |
| PUCCH | Physical Uplink Control |
| | Channel |
| PUSCH | Physical Uplink Shared |
| | Channel |
| QAM | Quadrature Amplitude |
| | Modulation |
| QCI | QoS identifier |
| QCL | Quasi location |
| QFI | QoS Flow ID, QoS Flow |
| | Identifier |
| QoS | Quality of Service |
| QPSK | Quadrature (Quaternary) |
| | Phase Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access Channel |
| RADIUS | Remote Authentication |
| | Dial In User Service |
| RAN | Radio Access Network |
| RAND | RANDom number (used |
| | for authentication) |
| RAR | Random Access Response |
| RAT | Radio Access Technology |
| RAU | Routing Area Update |
| RB | Resource block, Radio |
| | Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control layer |
| RLC AM | RLC Acknowledged Mode |
| RLC UM | RLC Unacknowledged |
| | Mode |
| RLF | Radio Link Failure |
| RLM | Radio Link Monitoring |
| RLM-RS | Reference Signal for RLM |
| RM | Registration Management |
| RMC | Reference Measurement |
| | Channel |
| RMSI | Remaining MSI, Remaining |
| | Minimum System |
| | Information |
| RN | Relay Node |
| RNC | Radio Network Controller |
| RNL | Radio Network Layer |
| RNTI | Radio Network Temporary |
| | Identifier |
| ROHC | RObust Header |
| | Compression |
| RRC | Radio Resource Control, |
| | Radio Resource Control |
| | layer |
| RRM | Radio Resource Management |
| RS | Reference Signal |
| RSRP | Reference Signal Received |
| | Power |
| RSRQ | Reference Signal Received |
| | Quality |
| RSSI | Received Signal Strength |
| | Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | SI Application Protocol |
| S1-MME | S1 for the control plane |
| S1-U | S1 for the user plane |
| S-CSCF | serving CSCF |
| S-GW | Serving Gateway |
| S-RNTI | SRNC Radio Network |
| | Temporary Identity |
| S-TMSI | SAE Temporary Mobile |
| | Station Identifier |
| SA | Standalone operation mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability Exposure |
| | Function |
| SC-FDMA | Single Carrier Frequency |
| | Division Multiple Access |
| SCG | Secondary Cell Group |
| SCM | Security Context |
| | Management |
| SCS | Subcarrier Spacing |
| SCTP | Stream Control Transmission |
| | Protocol |
| SDAP | Service Data Adaptation |
| | Protocol, Service Data |
| | Adaptation Protocol layer |
| SDL | Supplementary Downlink |
| SDNF | Structured Data Storage |
| | Network Function |
| SDP | Session Description Protocol |
| SDSF | Structured Data Storage |
| | Function |
| SDT | Small Data Transmission |
| SDU | Service Data Unit |
| SEAF | Security Anchor Function |
| SeNB | secondary eNB |
| SEPP | Security Edge Protection |
| | Proxy |
| SFI | Slot format indication |
| SFTD | Space-Frequency Time |
| | Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management |
| | Function |
| SMS | Short Message Service |
| SMSF | SMS Function |
| SMTC | SSB-based Measurement |
| | Timing Configuration |
| SN | Secondary Node, Sequence |
| | Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization |
| | Signal Block |
| SSID | Service Set Identifier |
| SS/PBCH | SSBRI SS/PBCH |
| Block | Block Resource Indicator, |
| | Synchronization |
| | Signal Block Resource |
| | Indicator |
| SSC | Session and Service |
| | Continuity |
| SS-RSRP | Synchronization |
| | Signal based Reference |
| | Signal Received Power |
| SS-RSRQ | Synchronization |
| | Signal based Reference |
| | Signal Received Quality |
| SS-SINR | Synchronization Signal |
| | based Signal to Noise and |
| | Interference Ratio |
| SSS | Secondary Synchronization |
| | Signal |
| SSSG | Search Space Set Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration |
| | Indicator |
| TCP | Transmission Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network Layer |
| TPC | Transmit Power Control |
| TPMI | Transmitted Precoding |
| | Matrix Indicator |
| TR | Technical Report |
| TRP, TRxP | Transmission Reception |
| | Point |
| TRS | Tracking Reference Signal |
| TRx | Transceiver |
| TS | Technical Specifications, |
| | Technical Standard |
| TTI | Transmission Time Interval |
| Tx | Transmission, Transmitting, |
| | Transmitter |
| U-RNTI | UTRAN Radio Network |
| | Temporary Identity |
| UART | Universal Asynchronous |
| | Receiver and Transmitter |
| UCI | Uplink Control Information |
| UE | User Equipment |
| UDM | Unified Data Management |
| UDP | User Datagram Protocol |
| UDSF | Unstructured Data Storage |
| | Network Function |
| UICC | Universal Integrated Circuit |
| | Card |
| UL | Uplink |
| UM | Unacknowledged Mode |
| UML | Unified |
| | Modelling Language |
| UMTS | Universal Mobile |
| | Telecommunications System |
| UP | User Plane |
| UPF | User Plane Function |
| URI | Uniform Resource |
| | Identifier |
| URL | Uniform Resource Locator |
| URLLC | Ultra-Reliable and Low |
| | Latency |
| USB | Universal Serial Bus |
| USIM | Universal Subscriber |
| | Identity Module |
| USS | UE-specific search space |
| UTRA | UMTS Terrestrial Radio |
| | Access |
| UTRAN | Universal Terrestrial Radio |
| | Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure |
| | Manager |
| VL | Virtual Link, VLAN Virtual |
| | LAN, Virtual Local Area |
| | Network |
| VM | Virtual Machine |
| VNF | Virtualized Network Function |
| VNFFG | VNF Forwarding Graph |
| VNFFGD | VNF Forwarding Graph |
| | Descriptor |
| VNFM | VNF Manager |
| VoIP | Voice-over-IP, Voice-over- |
| | Internet Protocol |
| VPLMN | Visited Public Land Mobile |
| | Network |
| VPN | Virtual Private Network |
| VRB | Virtual Resource Block |
| WiMAX | Worldwide Interoperability |
| | for Microwave Access |
| WLAN | Wireless Local Area |
| | Network |
| WMAN | Wireless Metropolitan Area |
| | Network |
| WPAN | Wireless Personal Area |
| | Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. A user equipment (UE) comprising:
one or more processors; and
one or more non-transitory computer-readable media comprising instructions that, upon execution of the instructions by the one or more processors, are to cause the UE to:
perform, in a first slot of a plurality of slots, a listen before talk (LBT) procedure related to a new radio (NR) sidelink (SL) transmission;
identify a subset of two or more candidate slots of the plurality of slots for transmission of a hybrid automatic repeat request (HARQ) message related to the LBT procedure; and
transmit the HARQ message in a candidate slot of the two or more candidate slots.

22. The UE of claim 21, wherein the subset of two or more candidate slots includes four candidate slots.

23. The UE of claim 21, wherein transmission of the HARQ message includes transmission of the HARQ message in a physical SL feedback channel (PSFCH) transmission.

24. The UE of claim 21, wherein transmitting the HARQ message is performed via unicast transmission.

25. The UE of claim 21, wherein transmitting the HARQ message is performed via groupcast transmission.

26. The UE of claim 21, wherein transmitting the HARQ message is performed via broadcast transmission.

27. The UE of claim 21, wherein a non-candidate slot is between respective slots of the two or more candidate slots in the plurality of slots.

28. The UE of claim 21, wherein the NR SL transmission is a physical SL control channel (PSCCH) transmission or a physical SL shared channel (PSSCH) transmission.

29. An apparatus for use in a user equipment (UE), wherein the apparatus comprises:
memory to store a generated new radio (NR) sidelink (SL) transmission; and
one or more processors configured to:
facilitate transmission, by the UE, of the NR SL transmission; and
identify, in a slot of a subset of two or more candidate slots of a plurality of slots, a hybrid automatic repeat request (HARQ) message based on a listen before talk (LBT) procedure performed in a first slot of the plurality of slots, wherein the LBT procedure is related to the NR SL transmission.

30. The apparatus of claim 29, wherein the subset of two or more candidate slots includes four candidate slots.

31. The apparatus of claim 29, wherein identification of the HARQ message includes identification of the HARQ message in a physical SL feedback channel (PSFCH) transmission.

32. The apparatus of claim 29, wherein the HARQ message is to be transmitted via unicast transmission.

33. The apparatus of claim 29, wherein the HARQ message is to be transmitted via groupcast transmission.

34. The apparatus of claim 29, wherein the HARQ message is to be transmitted via broadcast transmission.

35. The apparatus of claim 29, wherein a non-candidate slot is between respective slots of the two or more candidate slots in the plurality of slots.

36. The apparatus of claim 29, wherein the NR SL transmission is a physical SL control channel (PSCCH) transmission or a physical SL shared channel (PSSCH) transmission.

37. One or more non-transitory computer-readable media (NTCRM) comprising instructions that, upon execution of the instructions by one or more processors of a user equipment (UE), are to cause the UE to:
perform, in a first slot of a plurality of slots, a listen before talk (LBT) procedure related to a new radio (NR) sidelink (SL) transmission;
identify a subset of two or more candidate slots of the plurality of slots for transmission of a hybrid automatic repeat request (HARQ) message related to the LBT procedure; and
transmit the HARQ message in a candidate slot of the two or more candidate slots.

38. The one or more NTCRM of claim 37, wherein the subset of two or more candidate slots includes four candidate slots.

39. The one or more NTCRM of claim 37, wherein transmission of the HARQ message includes transmission of the HARQ message in a physical SL feedback channel (PSFCH) transmission.

40. The one or more NTCRM of claim 37, wherein a non-candidate slot is between respective slots of the two or more candidate slots in the plurality of slots.
